(19) United States
(12) Patent Application Publication
(10) Pub. No.: US 2010/0055943 A1
(43) Pub. Date: Mar. 4, 2010

(54) CIRCUIT BOARD FOR MEMORY CARD, AND MEMORY CARD HAVING THE SAME

(76) Inventor: Jeong Hyun PARK, Seoul (KR)

Correspondence Address: LADAS & PARRY LLP, 224 SOUTH MICHIGAN AVENUE, SUITE 1600, CHICAGO, IL, 60604, US

(21) Appl. No.: 12/260,454

(22) Filed: Oct. 29, 2008

(30) Foreign Application Priority Data
Aug. 29, 2008 (KR) 10-2008-0085394

(51) Int. Cl. H01R 12/00

(52) U.S. Cl. 439/78

(57) ABSTRACT

A circuit board for a memory card includes a circuit board body having a chip region and a peripheral region defined along a periphery of the chip region. The circuit board body includes circuit lines and element mounting parts which provide receiving spaces in the peripheral region. First connection pads are located in the peripheral region and are connected to the circuit lines. Second connection pads are located adjacent to the element mounting parts and are connected to the circuit lines. Passive elements are mounted in the element mounting parts so that at least a portion of the passive elements are formed within the circuit board body, and the passive elements are electrically connected to the second connection pads.

### CROSS-REFERENCE TO RELATED APPLICATIONS

The present application claims priority to Korean patent application number 10-2008-0085394 filed on Aug. 29, 2008, which is incorporated herein by reference in its entirety.

### BACKGROUND OF THE INVENTION

The present invention relates generally to memory cards, and more particularly to a circuit board for a memory card, and a memory card having the same.

Recent developments in semiconductor chip technology have resulted in semiconductor chips capable of storing massive amounts of data and processing these massive amounts of data within a relatively short period of time and memory cards having the semiconductor chips.

Developments in the manufacturing process of semiconductor chips and semiconductor packages have allowed manufacturers to gradually decrease the sizes of various electronic products such as mobile products, MP3 players, and portable data storage devices while maintaining the ability to store and process a massive amount of data.

Further, developments in semiconductor packaging techniques allow data storage devices to take the shape of cards. Some examples of data storage devices having the shape of cards include secure digital (SD) cards, mini SD cards, and micro SD cards.

Among these cards, the micro SD cards are mounted with flash memory chips and are mainly used in portable devices. The micro SD cards are widely applied various electronic products, such as portable GPS devices, MP3 players, game consoles, and extended type USB flash memory drives.

The micro SD cards are the smallest memory cards from among the card shaped devices mentioned above. The standard micro SD card has a length of 15 mm, a width of 11 mm and a thickness of 0.7 to 1 mm. A micro SD card is about ¼ of the size of an SD card.

A conventional micro SD card includes a board, a memory semiconductor chip which is mounted to the board and stores data, a control semiconductor chip which processes the data stored in the memory semiconductor chip, and passive elements such as resistors and capacitors.

In order to improve the functionality of the micro SD cards, high performance capacitors having high capacitance are required in the micro SD cards. However, the application of high performance capacitors to micro SD cards have caused the thickness of micro SD cards to increase to a level above the prescribed thickness, which in turn causes problems.

### SUMMARY OF THE INVENTION

Embodiments of the present invention are directed to a circuit board for a memory card, to which a high performance capacitor having high capacitance is mounted while satisfying a prescribed thickness.

Also, embodiments of the present invention are directed to a memory card having the circuit board.

In one aspect of the present invention, a circuit board for a memory card comprises a circuit board body having a chip region, a peripheral region which is defined along a periphery of the chip region, circuit lines, and element mounting parts which provide receiving spaces in the peripheral region; first connection pads located in the peripheral region and connected with the circuit lines; second connection pads located adjacent to the element mounting parts and connected to the circuit lines; and passive elements mounted in the element mounting parts and electrically connected to the second connection pads.

The element mounting parts comprise through-holes which pass through the circuit board body while extending from an upper surface to a lower surface, facing away from the upper surface, of the circuit board body.

The circuit board further comprises connection members electrically connecting the passive elements and the second connection pads.

The passive elements comprise at least one of a capacitor, a resistor, and an inductor.

The element mounting parts may alternatively comprise recesses defined on the upper surface of the circuit board body.

In another aspect of the present invention, a memory card comprises a circuit board including a circuit board body which has a chip region, a peripheral region defined along a periphery of the chip region, circuit lines and element mounting parts formed concavely in the peripheral region, first connection pads which are located in the peripheral region adjacent to the element mounting parts and are connected to the circuit lines, and second connection pads which are located in the peripheral region and are connected to the circuit lines; passive elements mounted in the element mounting parts and electrically connected with the first connection pads; a semiconductor chip module located in the chip region and electrically connected to the second connection pads; and a molding member covering the semiconductor chip module and the passive elements.

The element mounting parts comprise through-holes which pass through the semiconductor chip body while extending from an upper surface to a lower surface, facing away from the upper surface, of the circuit board body.

The memory card further comprises an insulation tape placed on the lower surface of the circuit board body to cover the passive elements exposed on the lower surface.

Alternatively, the memory card further comprises a molding member or a coating layer placed on the lower surface of the circuit board body to cover the passive elements exposed on the lower surface.

The semiconductor chip module includes a memory semiconductor chip for storing data and a control semiconductor chip for processing data.

The memory semiconductor chip is formed by stacking one or more semiconductor chips.

The molding member includes a first molding part which has a first thickness when measured from the upper surface of the circuit board body and a second molding part which has a second thickness greater than the first thickness when measured from the upper surface of the circuit board body.

The passive elements may be located at positions corresponding to the second molding part.

The passive elements may also be located at positions corresponding to the first molding part.

The passive elements may also be located at positions corresponding to the first and second molding parts.

The passive elements comprise at least one of a capacitor, a resistor, and an inductor.

The memory card further comprises connection members electrically connecting the passive elements and the first connection pads.

The element mounting parts may alternatively comprise recesses which are defined on the upper surface of the circuit board body.

### BRIEF DESCRIPTION OF THE DRAWINGS

FIG. 1 is a plan view showing a circuit board for a memory card in accordance with an embodiment of the present invention.

FIG. 2 is a cross-sectional view taken along the line I-I′ of FIG. 1.

FIG. 3 is a cross-sectional view showing a circuit board for a memory card according to another embodiment of the present invention.

FIG. 4 is a plan view showing a memory card in accordance with another embodiment of the present invention.

FIG. 5 is a cross-sectional view taken along the line II-II′ of FIG. 4.

FIG. 6 is a cross-sectional view taken along the line III-III′ of FIG. 4.

FIG. 7 is a cross-sectional view taken along the line IV-IV′ of FIG. 4.

### DESCRIPTION OF SPECIFIC EMBODIMENTS

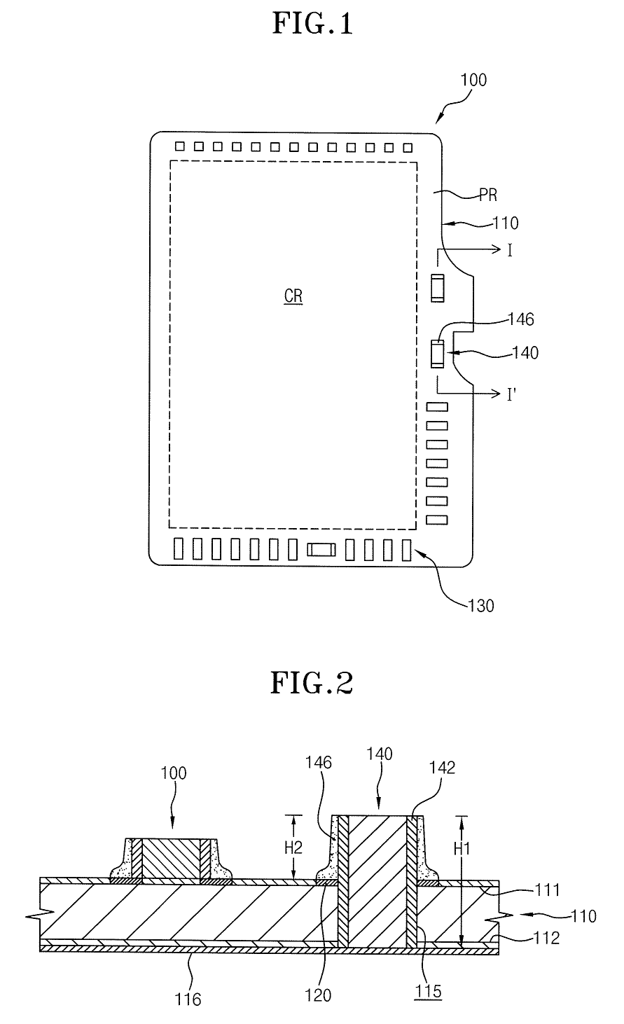

FIG. 1 is a plan view showing a circuit board for a memory card in accordance with an embodiment of the present invention. FIG. 2 is a cross-sectional view taken along the line I-I′ of FIG. 1.

Referring to FIGS. 1 and 2, a circuit board 100 for a memory card includes a circuit board body 110, first connection pads 120, second connection pads 130, and passive elements 140. For example, the circuit board 100 according to this embodiment of the present invention may be applied to a micro SD card, or the like.

The circuit board body 110 comprises a printed circuit board having the configuration of, for example, a plate. When viewed from above, the circuit board body 110 may have the shape of a rectangle. However, the circuit board body 110 is not limited to this shape, and may instead take on a variety of different shapes. The circuit board body 110 has an upper surface 111 on which semiconductor chips (not shown) and the passive elements 140 are mounted, and a lower surface 112 facing away from the upper surface 111.

The circuit board body 110 has a chip region CR in which the semiconductor chips are mounted, and a peripheral region PR which is defined along the periphery of the chip region CR. The chip region CR has an area appropriate for mounting a semiconductor chip (for example, a memory semiconductor chip).

Referring to FIG. 2, the circuit board body 110 includes circuit lines (not shown) and element mounting parts 115.

The circuit lines are formed in the chip region CR and the peripheral region PR of the circuit board body 110.

One or more element mounting parts 115 are located in the peripheral region PR. The presence of the element mounting parts 115 allows the passive elements 140 to be positioned at least partially within the circuit board body 110; and as a result, the height H2 of the portions of the passive elements 140 projecting from the circuit board body 110 can be decreased.

Thus, the element mounting parts 115 provide receiving spaces allowing the passive elements 140 to be at least partially mounted in the circuit board body 110. In the present embodiment, the element mounting parts 115 comprise through-holes which pass through the circuit board body 110 extending from the upper surface 111 towards the lower surface 112 of the circuit board body 110. In the present embodiment, the depth of the through-holes is substantially the same as the thickness of the circuit board body 110.

Referring to FIG. 2, the first connection pads 120 are placed in the peripheral region PR. In more detail, the first connection pads 120 are placed adjacent to the element mounting parts 115. In the exemplary embodiment of the present invention shown in FIG. 2, a pair of first connection pads 120 are respectively placed on both sides of each element mounting part 115. The first connection pads 120, which are respectively placed on both sides of each element mounting part 115, are electrically connected to the circuit lines (not shown). The first connection pads 120 are also electrically connected with the passive elements 140 as will be described later.

The second connection pads 130 are placed in the peripheral region PR as well. The second connection pads 130 are placed, for example, on the upper surface 111 of the circuit board body 110. The second connection pads 130 are electrically connected to corresponding bonding pads (not shown) of the semiconductor chips (not shown) located in the chip region CR.

The passive elements 140 are placed in the receiving spaces defined by the element mounting parts 115 formed in the peripheral region PR of the circuit board body 110. In the present exemplary embodiment shown in FIG. 2, the passive elements 140 have the configuration of a rectangular hexahedron. However, the passive elements are not limited as such, and can be formed in a different shape depending upon the space defined by the element mounting parts 115. In the present embodiment, the passive elements 140, which are located in the receiving spaces defined by the respective element mounting parts 115, may comprise high performance capacitors having capacitance of, for example, about 1 μF. Alternatively, the passive elements 140 may comprise resistors or another type of passive element.

Referring again to FIG. 2, the passive elements 140 (which comprise, for example, the high performance capacitors having capacitance of about 1 μF) have a first height H1. Connection terminals 142 are electrically connected to first connection pads 120, are respectively placed on both side surfaces of the passive elements 140.

When the passive elements 140 are at least partially positioned in the element mounting parts 115 comprising the through-holes, a portion of the passive elements 140 project from the upper surface 111 of the circuit board body 110 by a second height H2.

The connection terminals 142 of the respective passive elements 140 (which are positioned in the element mounting parts 115) are electrically connected to the first connection pads 120 by way of connection members 146. In an exemplary embodiment of the present invention, the connection members 146 comprise solder. However, the connection members 146 may also comprise another suitable element for forming an electrical connection between the connection terminals 120 and the first connection pads 120.

When a passive element 140 is positioned in an element mounting part 115 that comprises a through-hole extending from the upper surface 111 to the lower surface 112, a first end of the passive element 140 is exposed at the lower surface 112 of the circuit board body 110. In order to protect the portion of the passive element 140 exposed at the lower surface 112 from any vibrations and/or shocks applied from the outside, a protective film 116 is attached to the lower surface 112 of the circuit board body 110. In one alternative embodiment, a molding member or a coating layer may be formed on the lower surface 116 of the circuit board body 110 in place of the protective film 116.

In the present embodiment, since the passive elements 140 are formed within the element mounting parts 114 and project from the upper surface 111 of the circuit board body 110 by the second height H2, the thickness standard of a micro SD card can be satisfied even when the micro SD card includes passive elements 140 having a high capacitance (such as, approximately 1 μF).

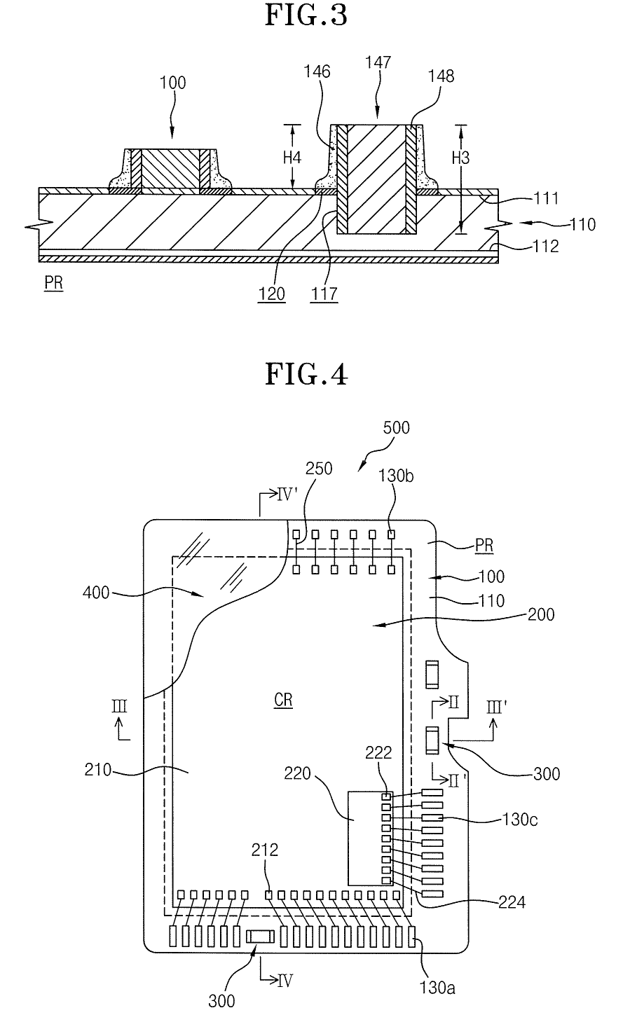

FIG. 3 is a cross-sectional view showing a circuit board for a memory card according to another embodiment of the present invention. The circuit board for a memory card according to this variation of the present invention can have essentially the same construction as the circuit board for a memory card described above with reference to FIGS. 1 and 2. The different between the construction of the circuit board shown in FIG. 3 and the circuit board shown in FIGS. 1 and 2 is the element mounting parts and the passive elements. Therefore, the same terms and the same reference numerals will be used to refer to the same or like parts.

Referring to FIG. 3, a circuit board 100 for a memory card includes a circuit board body 110, first connection pads 120, second connection pads 130, and passive elements 147. For example, the circuit board 100 according to this embodiment of the present invention may be applied to a micro SD card, or the like.

The circuit board body 110 includes circuit lines (not shown) and element mounting parts 117.

The circuit lines are formed in a chip region CR and a peripheral region PR of the circuit board body 110.

One or more element mounting parts 117 are located in the peripheral region PR. The element mounting parts 117 allow the passive elements 147 to be partially positioned in the circuit board body 110 as will be described below.

The element mounting parts 117 provide receiving spaces allowing the passive elements 147 to be partially mounted in the circuit board body 110. In the present embodiment, the element mounting parts 117 comprise recesses which are defined in the shape of grooves penetrating the upper surface 111 of the circuit board body 110 and extending partially within the circuit board body 110. In the present embodiment shown in FIG. 3, the depth of the element mounting parts 117 is less than the thickness of the circuit board body 110.

The passive elements 147 are placed in the receiving spaces of the circuit board body 110, which are defined by the element mounting parts 117 formed in the peripheral region PR of the circuit board body 110. In the present embodiment, the passive elements 147 may have, for example, the configuration of a rectangular hexahedron. However, the passive elements are not limited as such, and can be formed in a different shape depending upon the space defined by the element mounting parts 115. In the present embodiment, the passive elements 147, which are located in the receiving spaces defined by the respective element mounting parts 117, may comprise high performance capacitors.

Alternatively, the passive elements 147 may comprise resistors or another type of passive element.

The passive elements 147 (which comprise, for example, high performance capacitors) have a third height H3. Connection terminals 148, which are electrically connected to the first connection pads 120, are respectively placed on both side surfaces of the passive elements 147.

When the passive elements 147 having the third height H3 are partially positioned in the element mounting parts 117 formed as recesses, the passive elements 147 project from the upper surface 111 of the circuit board body 110 by a fourth height H4. Attributable to this fact, the thickness standard of a micro SD card can be satisfied even when the micro SD card includes the passive elements 147 having high capacitance.

The connection terminals 148 of respective passive elements 147 (which are positioned in the element mounting parts 117) are electrically connected to the first connection pads 120 by way of connection members 146. In an exemplary embodiment of the present invention, the connection members 146 comprise solder. However, the connection members 146 may also comprise another suitable element for forming an electrical connection between the connection terminals 120 and the first connection pads 120.

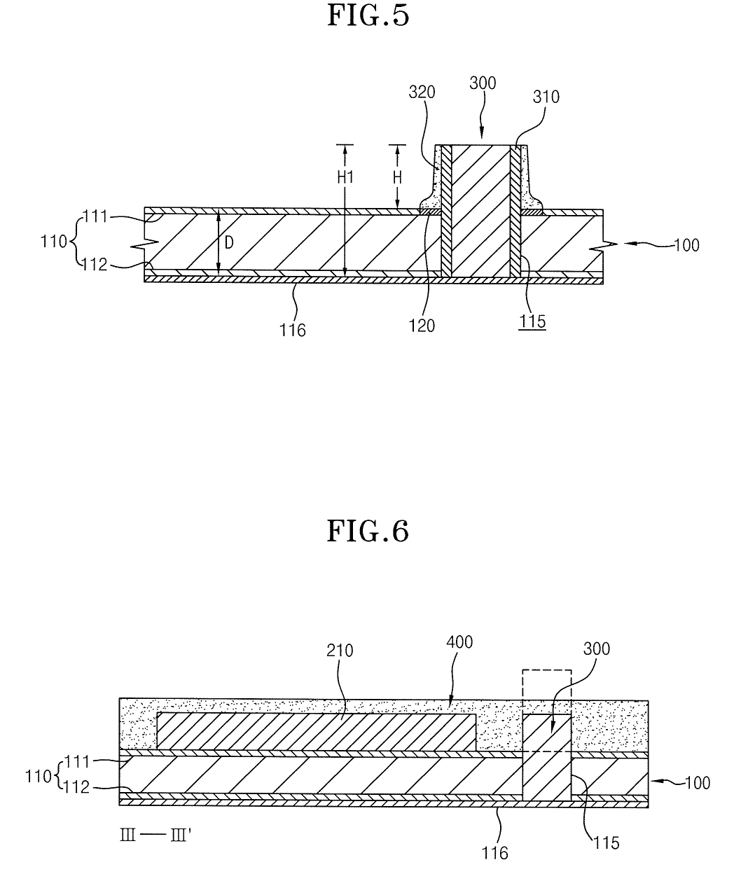

FIG. 4 is a plan view showing a memory card in accordance with another embodiment of the present invention. FIG. 5 is a cross-sectional view taken along the line II-II′ of FIG. 4.

Referring to FIGS. 4 and 5, a memory card 500 includes a circuit board 100, a semiconductor chip module 200, passive elements 300, and a molding member 400.

The circuit board 100 includes a circuit board body 110, first connection pads 120, and second connection pads 130. For example, the circuit board 100 according to this embodiment of the present invention may be applied to a micro SD card, or the like.

The circuit board body 110 comprises a printed circuit board having the configuration of, for example, a plate. When viewed from above, the circuit board body 110 has the shape of a rectangle. However, the circuit board body 110 is not limited to this shape, and may instead take on a variety of different shapes. The circuit board body 110 has an upper surface 111 and a lower surface 112 facing away from the upper surface 111, as shown in FIG. 5.

The circuit board body 110 has a chip region CR in which the semiconductor chips are mounted, and a peripheral region PR which is defined along the periphery of the chip region CR.

The circuit board body 110 includes circuit lines (not shown) and element mounting parts 115.

The circuit lines are formed in the chip region CR and the peripheral region PR of the circuit board body 110.

One or more element mounting parts 115 are located in the peripheral region PR. The presence of the element mounting parts 115 allows the passive elements 300 to be at least partially positioned in the circuit board body 110.

The element mounting parts 115 provide receiving spaces allowing the passive elements 300 to be at least partially mounted in the circuit board body 110. In the present embodiment, the element mounting parts 115 comprise through-holes which pass through the circuit board body 110 extending from the upper surface 111 to the lower surface 112 of the circuit board body 110. In FIG. 5, the thickness of the element mounting parts 115 is designated by the reference symbol D. Alternatively, the element mounting parts 115 may comprise recesses penetrating the upper surface 111 and extending partially in the circuit board body 110. In this case, the depth of the recesses is less than the thickness of the circuit board body 110.

Referring to FIG. 4, the first connection pads 120 are placed in the peripheral region PR.

In more detail, first connection pads 120 are placed adjacent to the respective element mounting parts 115. For example, a pair of first connection pads 120 are respectively placed on both sides of each element mounting part 115. A first connection pads 120 is placed on both sides of each element mounting part 115, and the first connection pads 120 are electrically connected to the circuit lines.

The second connection pads 130 are placed in the peripheral region PR as well. In the embodiment of the present invention shown in FIG. 4, a plurality of second connection pads 130 are aligned adjacent to the edges of the upper surface 111 of the circuit board body 110. Hereinafter, the second connection pads 130 are defined as first connection pad parts 130a, second connection pad parts 130b, and third connection pad parts 130c.

The passive elements 300 are placed in the receiving spaces of the circuit board body 110, which are defined by the element mounting parts 115 formed in the peripheral region PR of the circuit board body 110. In the present embodiment, the passive elements 300 may have, for example, the configuration of a rectangular hexahedron. However, the connection members 146 may also comprise another suitable element for forming an electrical connection between the connection terminals 120 and the first connection pads 120. In the present embodiment, the passive elements 300, which are located in the receiving spaces defined by the respective element mounting parts 115, may comprise high performance capacitors having capacitance of, for example, about 1 μF. Alternatively, the passive elements 300 may comprise resistors.

Referring to FIG. 5, the passive elements 300 (which comprise, for example, the high performance capacitors having capacitance of about 1 μF) have a first height H1. Connection terminals 310 are electrically connected to the first connection pads 120, are respectively placed on both side surfaces of the passive elements 300.

When the passive elements 300 having the first height H1 are at least partially positioned in the element mounting parts 115 comprising the through-holes, the passive elements 300 project from the upper surface 111 of the circuit board body 110 by a second height H.

The connection terminals 310 of the respective passive elements 300 (which are positioned in the element mounting parts 115) are electrically connected to the first connection pads 120 by way of connection members 320. In an exemplary embodiment of the present invention, the connection members comprise solder. However, the connection members 320 may also comprise another suitable element for forming an electrical connection between the connection terminals 320 and the first connection pads 120.

When a passive element 300 is positioned in an element mounting part 115 that comprises a through-hole extending from the upper surface 111 to the lower surface 112, a first end of the passive elements 300 is exposed at the lower surface 112 of the circuit board body 110. In order to protect the portion of the passive element 300 exposed at the lower surface 112 from any vibrations and/or shocks applied from the outside, a protective film 116 is attached to the lower surface 112 of the circuit board body 110. In one alternative embodiment, a molding member or a coating layer may be formed on the lower surface 116 of the circuit board body 110 in place of the protective film.

Referring again to FIG. 4, the semiconductor chip module 200 is located in the chip region CR of the circuit board body 110. For example, the semiconductor chip module 200 includes a memory semiconductor chip 210 and a control semiconductor chip 220. In one embodiment of the present invention, one or more memory semiconductor chips 210 for storing data may be stacked upon each other. The control semiconductor chip 220 controls the input and output of data to and from the memory semiconductor chip 210, and can be located on the memory semiconductor chip 210.

The memory semiconductor chip 210 has the configuration of, for example, a rectangular hexahedron having a small thickness; however, the memory semiconductor chip 210 is not limited to this shape. Bonding pads 212 are located adjacent to the opposing edges of the memory semiconductor chip 210. The bonding pads 212 adjoin the first connection pad parts 130a and the second connection pad parts 130b of the second connection pads 130. The bonding pads 212 of the memory semiconductor chip 210 and the first and second connection pad parts 130a and 130b are electrically connected to each other by, for example, conductive wires 250.

The control semiconductor chip 220, which is located on the memory semiconductor chip 210, is placed at a position adjoining the third connection pad parts 130c of the second connection pads 130. The control semiconductor chip 220 has bonding pads 222 which correspond to the third connection pad parts 130c. The bonding pads 222 of the control semiconductor chip 220 and the third connection pad parts 130c are electrically connected to each other by, for example, conductive wires 224.

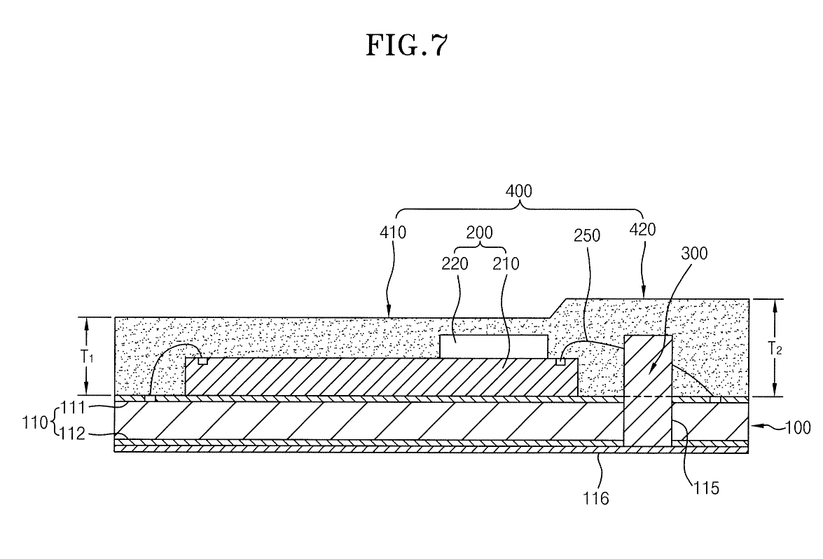

FIG. 6 is a cross-sectional view taken along the line III-III′ of FIG. 4. FIG. 7 is a cross-sectional view taken along the line IV-IV′ of FIG. 4.

Referring to FIG. 6, a molding member 400 is placed on the upper surface 111 of the circuit board body 110. The molding member 400 covers the passive elements 300 and the semiconductor chip module 200. The molding member 400 can be formed of, for example, epoxy resin.

Referring to FIG. 7, in the present embodiment, the molding member 400 includes a first molding part 410 and a second molding part 420. When measured from the upper surface 111 of the circuit board body 110, the first molding part 410 has a first thickness T1, and the second molding part 420 has a second thickness T2 greater than the first thickness T1. In the present embodiment, the second molding part 420 having the second thickness T2 covers the passive elements 300 mounted on the circuit board body 110.

In the present embodiment, the passive elements 300 can be located in the peripheral region PR of the circuit board body 110 to correspond to the first molding part 410 as shown in FIG. 6. In one alternative, the passive elements 300 may be located in the peripheral region PR of the circuit board body 110 to correspond to the second molding part 420 as shown in FIG. 7. In another alternative, the passive elements 300 may be located in the peripheral region PR of the circuit board body 110 to correspond to the first and second molding parts 410 and 420 as shown in FIG. 4.

As is apparent from the above description, in the present invention, passive elements such as capacitors having high capacitance can be mounted to a memory card such as a micro SD card, whereby the performance of the memory card can be improved while satisfying the standard thickness of the memory card.

Although specific embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. A circuit board for a memory card, comprising:
a circuit board body having a chip region and a peripheral region defined along a periphery of the chip region, the circuit board body comprising:
circuit lines; and
an element mounting part formed in the circuit board body to form a receiving space in the peripheral region;
first connection pads disposed in the peripheral region and connected to the circuit lines;
one or more second connection pads disposed adjacent to the element mounting part and connected to the circuit lines; and
a passive element mounted in the element mounting part and electrically connected to the one or more second connection pads.

2. The circuit board according to claim 1, wherein the element mounting part comprises a through-hole passing through the circuit board body and extending from an upper surface to a lower surface, facing away from the upper surface, of the circuit board body.

3. The circuit board according to claim 1, further comprising:
one or more connection members formed on the one or more second connection pads and electrically connecting the passive element to the one or more second connection pads.

4. The circuit board according to claim 1, wherein the passive element comprises at least one of a capacitor, a resistor, and an inductor.

5. The circuit board according to claim 1, wherein the element mounting part comprises a recess penetrating an upper surface of the circuit board body and extending partially into the circuit board body.

6. A memory card comprising:
a circuit board comprising:
a circuit board body having a chip region and a peripheral region defined along a periphery of the chip region, the circuit board body comprising:
circuit lines; and
one or more element mounting parts each formed in the circuit board body in the peripheral region,
one or more first connection pads each disposed in the peripheral region adjacent to a respective one of the element mounting parts, the first connection pads being electrically connected to the circuit lines; and
one or more second connection pads each disposed in the peripheral region, the second connection pads being electrically connected to the circuit lines;
one or more passive elements each mounted in a respective element mounting part, the passive elements being electrically connected to the first connection pads;
a semiconductor chip module located in the chip region and electrically connected to the second connection pads; and
a molding member covering the semiconductor chip module and the passive elements.

7. The memory card according to claim 6, wherein each of the element mounting parts comprises a through-hole passing through the circuit board body and extending from an upper surface to a lower surface, facing away from the upper surface, of the circuit board body.

8. The memory card according to claim 7, further comprising:
an insulation tape disposed on the lower surface of the circuit board body to cover the passive elements exposed on the lower surface.

9. The memory card according to claim 7, further comprising:
a molding member or a coating layer disposed on the lower surface of the circuit board body to cover the passive elements exposed on the lower surface.

10. The memory card according to claim 6, wherein the semiconductor chip module includes a memory semiconductor chip for storing data and a control semiconductor chip for processing data.

11. The memory card according to claim 10, wherein the memory semiconductor chip is formed by stacking one or more semiconductor chips.

12. The memory card according to claim 6, wherein the molding member includes a first molding part having a first thickness when measured from the upper surface of the circuit board body and a second molding part having a second thickness greater than the first thickness when measured from the upper surface of the circuit board body.

13. The memory card according to claim 12, wherein the passive elements are located at positions corresponding to the second molding part.

14. The memory card according to claim 12, wherein the passive elements are located at positions corresponding to the first molding part.

15. The memory card according to claim 12, wherein some of the passive elements are located at positions corresponding to the first molding part and the remaining passive elements are located at positions corresponding to the second molding part.

16. The memory card according to claim 6, wherein each of the passive elements comprises at least one of a capacitor, a resistor, and an inductor.

17. The memory card according to claim 6, further comprising:
connection members each electrically connecting a respective one of the passive elements to a corresponding one of the first connection pads.

18. The memory card according to claim 6, wherein each of the element mounting parts comprises a recess penetrating an upper surface of the circuit board body and extending partially into the circuit board body.
